(19) United States
(12) Patent Application Publication
(10) Pub. No.: US 2018/0024760 A1
(43) Pub. Date: Jan. 25, 2018

(54) INFORMATION PROCESSING DEVICE, INFORMATION PROCESSING SYSTEM, AND NON-TRANSITORY COMPUTER-READABLE STORAGE MEDIUM

(71) Applicant: FUJITSU LIMITED, Kawasaki-shi (JP)

(72) Inventor: Masatsuna TAKAHASHI, Numazu (JP)

(73) Assignee: FUJITSU LIMITED, Kawasaki-shi (JP)

(21) Appl. No.: 15/646,639

(22) Filed: Jul. 11, 2017

(30) Foreign Application Priority Data
Jul. 21, 2016 (JP) 2016-143522

(51) Int. Cl. G06F 3/06; G06F 13/18

(52) U.S. Cl. CPC G06F 3/0619; G06F 3/065; G06F 3/067; G06F 13/18

(57) ABSTRACT

An information processing device including a memory that stores priority information indicating a plurality of priorities for each of a plurality of paths used for access by a plurality of jobs to a storage device which stores data to be accessed, and a processor coupled to the memory and the processor configured to, during a copying process of the data, specify a progress degree of a copying process, and perform control of a band width allocation for at least one of the plurality of paths based on the priority information stored in the memory and based on the progress degree of a copying process of the data.

### CROSS-REFERENCE TO RELATED APPLICATION

This application is based upon and claims the benefit of priority of the prior Japanese Patent Application No. 2016-143522, filed on Jul. 21, 2016, the entire contents of which are incorporated herein by reference.

### FIELD

The embodiment discussed herein is related to an information processing device, an information processing system, and a non-transitory computer-readable storage medium.

### BACKGROUND

In an information processing system which executes a job program, data to be used in a job is stored in a storage and copies of the data are created for backup, snapshot, and the like. In many cases, a completion time of a copying process of copying the data is determined such as a start time of the job or a loading time in the case of loading the backup data to the outside.

When a front job occurs during the copying process, the copying process is delayed and eventually may not be completed before the determined completion time. Here, the front job is a job of accessing the storage under the copying process. In order to avoid delay of the copying process, a band limitation is imposed on a job path between the front job and the storage.

Regarding the band limitation, there is a technique in which, when congestion occurs in a physical port connecting an initiator and targets, the band of the physical port is managed by controlling band usage of each of at least two targets based on the minimum and maximum band setting of each target.

Moreover, there is a technique of providing uniform service by obtaining a product of the total elapsed time of each of jobs on a processing request waiting que and a resource distribution ratio assigned to the job, determining a priority order of the jobs in descending order of the products, and assigning processing requests to a processing device according to the priority order.

Furthermore, there is a technique of performing a processing delay check job to detect a processing delay of a batch job and automatically notifying an operation manager of the impact of the delay and the measures against the delay depending on the delay time, thereby enabling execution of optimal processing delay measures.

Moreover, there is a technique in which: multiple groups in a plant are classified into levels in a hierarchal structure in order to cope with state changes which may occur in the groups; and the state changes, warning signals, and the like for all the levels of the hierarchal structure are printed out in a format in which the state changes, the warning signals, and the like are associated with one another, thereby facilitating investigation of the cause of a state change, a warning signal, or the like, if it occurs.

The conventional techniques described above are disclosed in Japanese National Publication of International Patent Application No. 2007-536612 and Japanese Laid-open Patent Publication Nos. 63-317833, 2012-146049, and 63-303479.

### SUMMARY

According to an aspect of the invention, an information processing device including a memory that stores priority information indicating a plurality of priorities for each of a plurality of paths used for access by a plurality of jobs to a storage device which stores data to be accessed, and a processor coupled to the memory and the processor configured to, during a copying process of the data, specify a progress degree of a copying process, and perform control of a band width allocation for at least one of the plurality of paths based on the priority information stored in the memory and based on the progress degree of a copying process of the data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a view for explaining parallel transition;

FIG. 1B is a view for explaining sequential transition;

FIG. 2 is a view for explaining switching from the sequential transition to the parallel transition;

FIG. 3 is a view for explaining how delay is avoided just before completion by changing a sampling interval;

FIGS. 4A to 4C are views for explaining control of lowering the priority of a copying process after a completion time;

FIG. 5 is a view depicting a configuration of an information processing system in an embodiment;

FIG. 6 is a view illustrating an example of a schedule table;

FIG. 7 is a view illustrating an example of a copy table;

FIG. 8 is a view illustrating an example of a RAID group table;

FIG. 9 is a view illustrating an example of a volume table;

FIG. 10 is a view illustrating an example of a path table;

FIG. 11 is a flowchart depicting a flow of processes performed by a sequential transition unit;

FIG. 12 is a flowchart depicting a flow of processes performed by a parallel transition unit; and

FIG. 13 is a view illustrating a hardware configuration of a computer which executes a management program in the embodiment.

### DESCRIPTION OF EMBODIMENT

The conventional technique of limiting bands for front jobs during a copying process has a problem that the rates of the front jobs are uniformly decreased and a fatal delay of an important front job occurs.

An object in one aspect of an embodiment is to suppress the delay of the important front job.

The embodiment of an information processing device, an information processing system, an information processing method, and a program disclosed in the present application are described below in detail based on the drawings. Note that the embodiment does not limit the disclosed technique.

First, description is given of priority control performed by the information processing system in the embodiment. The information processing system in the embodiment classifies the front jobs into high-priority jobs and low-priority jobs. Then, the information processing system in the embodiment classifies job paths connected to the front jobs into a priority path and a non-priority path, for all of volumes belonging to the same redundant arrays of inexpensive disk (RAID) group as a volume being the target of the copying process. The priority path is a job path connected to the high-priority front job and the non-priority path is a job path connected to the low-priority front job.

The classification of the job paths is performed for all volumes belonging to the same RAID group as the volume being the target of the copying process due to the following reason: since the effect of the priority control is small unless the priority control is performed in units of disk device, the RAID group formed of the disk devices is set as the target range of the control.

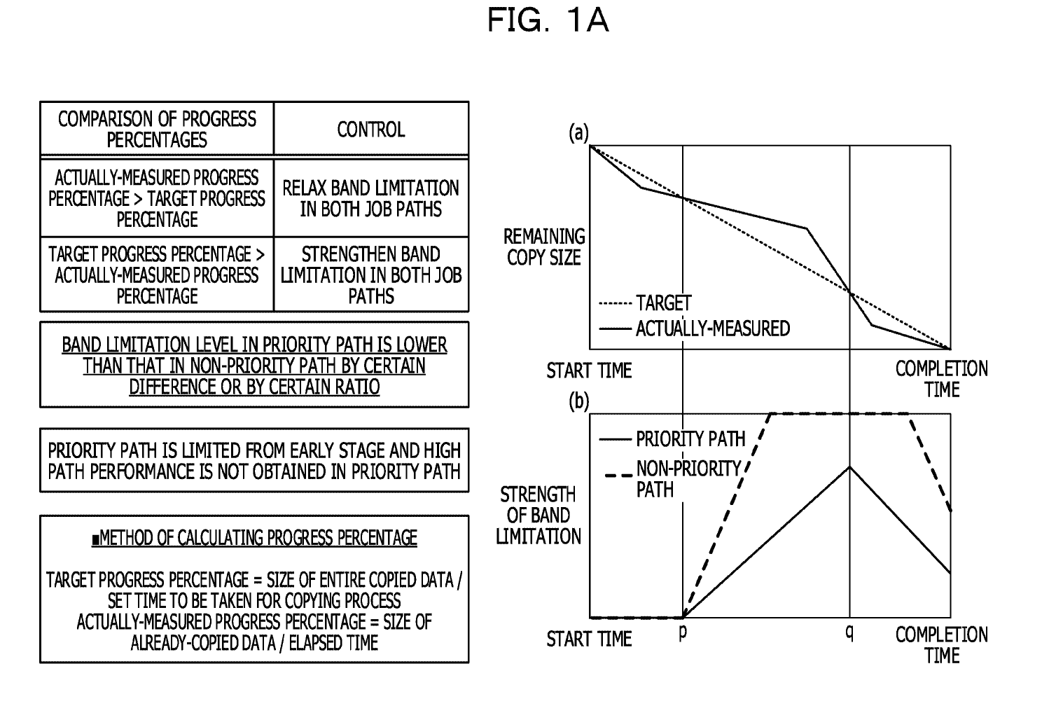

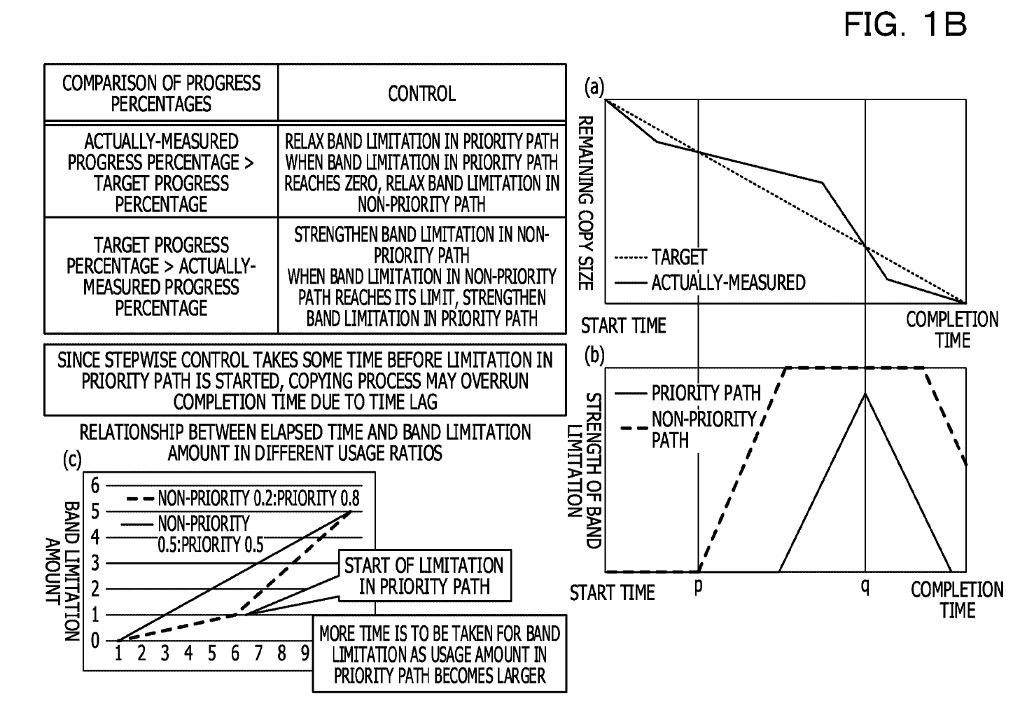

The information processing system in the embodiment performs priority control by using two methods of parallel transition and sequential transition for band limitation in the priority path and the non-priority path. FIG. 1A is a view for explaining the parallel transition, and FIG. 1B is a view for explaining the sequential transition.

As illustrated in FIG. 1A, in the parallel transition, the information processing system in the embodiment compares an actually-measured progress percentage and a target progress percentage. In this case, the actually-measured progress percentage is a value obtained by dividing the size of already-copied data by an elapsed time, and the target progress percentage is a value obtained by dividing the entire size of the data to be copied by a set time to be taken for the copying process. The set time to be taken for copying process is a time to be taken for the copying process which is set by the user.

Then, when the actually-measured progress percentage is higher than the target progress percentage, the information processing system in the embodiment relaxes the band limitation in both of the priority path and the non-priority path. Meanwhile, when the actually-measured progress percentage is lower than the target progress percentage, the information processing system in the embodiment strengthens the band limitation in both job paths.

In this case, relaxing the band limitation represents reducing a band limitation amount by a certain value, and strengthening the band limitation represents increasing the band limitation amount by a certain value. In other words, the information processing system in the embodiment performs the band limitation for the front jobs stepwise. Note that the band limitation level in the priority path is lower than that in the non-priority path by a certain difference or by a certain ratio.

Part (a) in FIG. 1A is a graph in which the horizontal axis represents the elapsed time of the copying process and the vertical axis represents the remaining copy size. The remaining copy size based on the target is depicted by the dotted line, and the remaining copy size based on the actual measurement is depicted by the solid line. When the solid line is below the dotted line, the copying process is proceeding at a higher rate than the target. Meanwhile, when the solid line is above the dotted line, the copying process is proceeding at a lower rate than the target. A time period in which the tilt of the solid line is smaller than the tilt of the dotted line is a time period in which the rate of the copying process is low due to the effect of the front jobs. Meanwhile, a time period in which the tilt of the solid line is greater than the tilt of the dotted line is a time period in which the band limitation for the front jobs is strengthened and the rate of the copying process is high.

Part (b) in FIG. 1A is a graph in which the horizontal axis represents the elapsed time as in part (a) and the vertical axis represents the strength of the band limitation. The strength of the band limitation in the priority path is depicted by the solid line and the strength of the band limitation in the non-priority path is depicted by the broken line. The band limitation level in the priority path is lower than that in the non-priority path by a certain ratio. The band limitation starts from the time point p at which the actually-measured progress percentage falls below the target progress percentage, and is relaxed from the time point q at which the actually-measured progress percentage exceeds the target progress percentage. Moreover, the strength of the band limitation in the non-priority path reaches its limit in the middle of the copying process.

In the parallel transition, the priority path is limited from an early stage and a high path performance may not be obtained in the priority path.

Meanwhile, as illustrated in FIG. 1B, in the sequential transition, when the actually-measured progress percentage is higher than the target progress percentage, the information processing system in the embodiment relaxes the band limitation in the priority path. When the band limitation in the priority path reaches zero, the information processing system in the embodiment relaxes the band limitation in the non-priority path. Meanwhile, when the actually-measured progress percentage is lower than the target progress percentage, the information processing system in the embodiment strengthens the band limitation in the non-priority path. When the band limitation in the non-priority path reaches its limit, the information processing system in the embodiment strengthens the band limitation in the priority path.

Part (a) of FIG. 18 is the same as part (a) of FIG. 1A but part (b) of FIG. 18 is different from part (b) of FIG. 1A. The band limitation in the non-priority path starts from the time point p at which the actually-measured progress percentage falls below the target progress percentage, and the band limitation in the priority path starts when the band limitation in the non-priority path reaches its limit.

Part (c) of FIG. 18 is a graph depicting relationships between the elapsed time and the band limitation amount in different usage ratios. In this case, the usage ratio is a ratio of a usage of the non-priority path to a usage of the priority path. The broken line depicts the case where the usage ratio of the non-priority path to the priority path is 0.2 to 0.8, and the solid line depicts the case where the usage ratio of the non-priority path to the priority path is 0.5 to 0.5. The higher the usage ratio of the priority path to the non-priority path is, the longer the time to be taken for the band limitation is.

In the subsequent transition, the stepwise control takes some time before the limitation in the priority path is started, and the copying process may overrun the completion time due to a time lag existing before the start of the limitation of the priority path. Particularly, when the usage ratio of the priority path is high, the copying process is highly-likely to overrun the completion time.

In other words, since the priority path is limited in an early stage in the parallel transition, it desirable to avoid use of the parallel transition at the start of the copying process. Meanwhile, since the delay of the priority control causes overrun of the completion time in the sequential control, it is desirable to avoid use of the sequential transition just before the completion of the copying process. Accordingly, the information processing system in the embodiment starts the priority control in the sequential transition and switches to the parallel transition in the middle of the copying process.

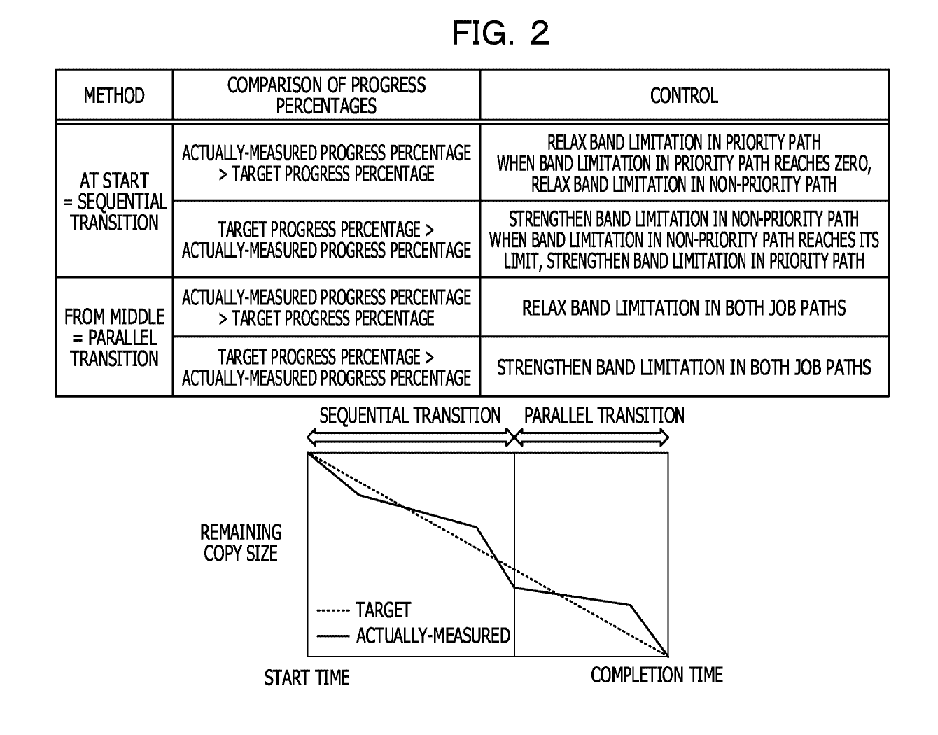

FIG. 2 is a view for explaining the switching from the sequential transition to the parallel transition. As illustrated in FIG. 2, the information processing system in the embodiment performs the priority control in the sequential transition at the start of the copying process and performs the priority control in the parallel transition from the middle of the copying process. As described above, the information processing system in the embodiment may avoid the priority path from being limited in an early stage and suppress the possibility of overrun of the completion time, by switching from the sequential transition to the parallel transition.

Moreover, the information processing system in the embodiment determines the timing of switching from the sequential transition to the parallel transition based on the remaining time. In order to avoid switching in periods close to the start and completion of the copying process, the information processing system in the embodiment sets the switching timing to be a timing at which the remaining time is 30% to 70%, for example, 40% of the entire process time. Note that the information processing system in the embodiment regularly checks the band limitation situation of the job paths and, in a situation where the usage ratio of the non-priority path is low and the band limitation in the priority path has to be continuously performed in the sequential transition, switches to the parallel transition earlier.

Note that the changing of the band limitation is performed at a certain sampling interval. Accordingly, it is possible to greatly change the band limitation when the sampling interval is short. For example, when the copying process is expected not to be completed before the completion time, the information processing system in the embodiment may complete the copying process before the completion time by reducing the sampling interval to greatly change the band limitation.

However, since a short sampling interval affects the system performance, the information processing system in the embodiment reduces the sampling interval only in limited situations such as just before the completion of the copying process. Just before the completion is, for example, a time period in which the remaining time is equal to or less than 10% of the entire process time.

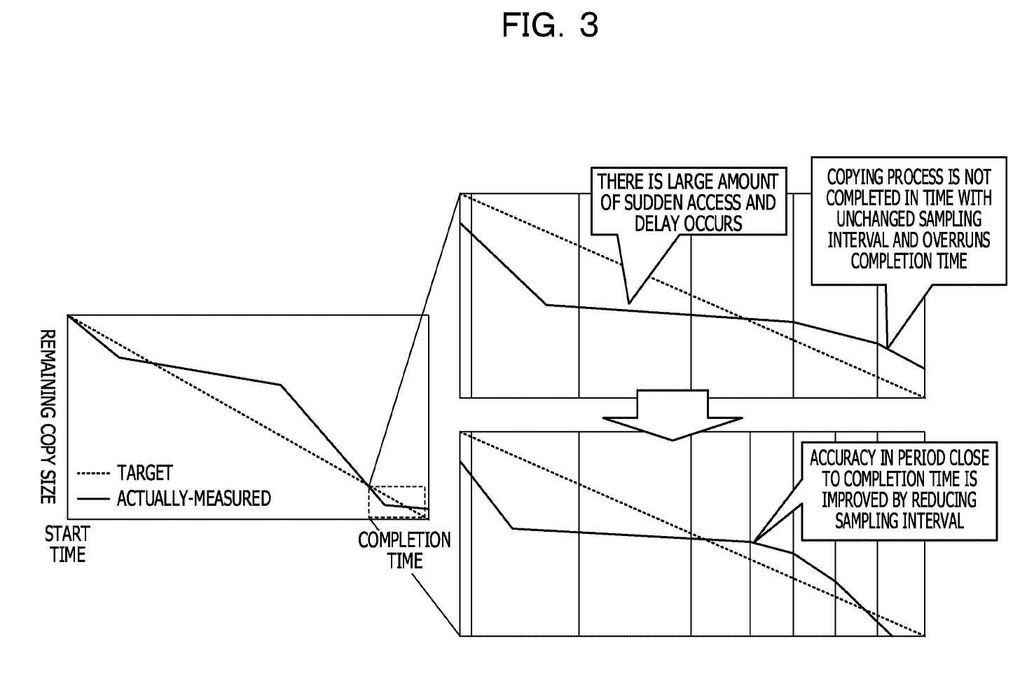

FIG. 3 is a view for explaining how delay is avoided just before the completion by changing the sampling interval. FIG. 3 illustrates the case where there is a large amount of sudden access just before the completion and delay occurs. As illustrated in FIG. 3, when the sampling interval is not changed, the band limitation may not be greatly changed. Accordingly, delay of the completion time occurs.

The information processing system in the embodiment may complete the copying process before the completion time by reducing the sampling interval just before the completion to greatly change the band limitation. In other words, the information processing system in the embodiment is capable of improving the accuracy of the completion time in the period close to the completion time by reducing the sampling interval just before the completion.

Moreover, in an environment in which the front jobs increase after the completion time, the operation of the front jobs is greatly affected when the copying process is executed beyond the completion time. Accordingly, the information processing system in the embodiment performs control of lowering the priority of the copying process after the completion time.

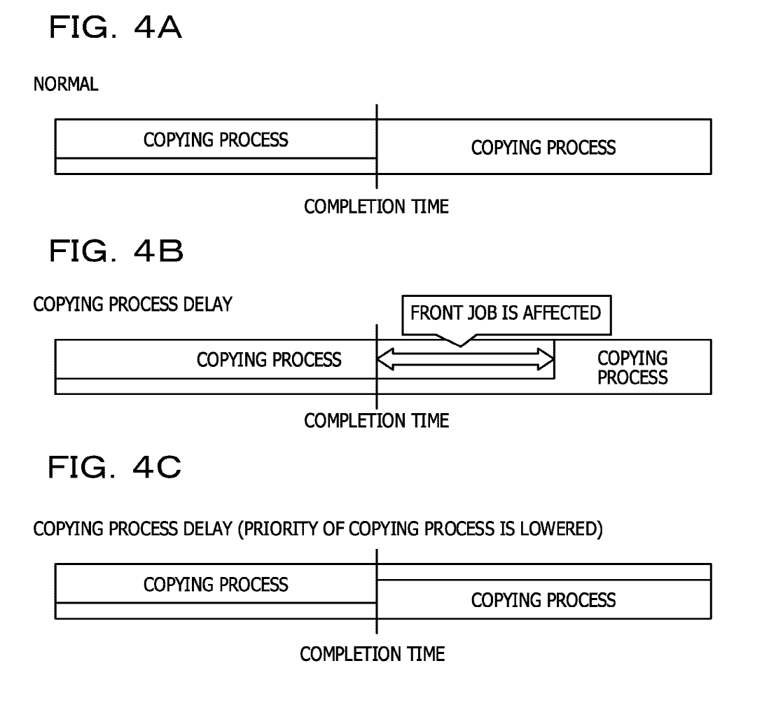

FIGS. 4A to 4C are views for explaining control of lowering the priority of the copying process after the completion time. As illustrated in FIG. 4A, since the copying process is generally completed at the completion time, the front jobs are not affected even when the front jobs increase after the completion time. Meanwhile, as illustrated in FIG. 4B, when delay occurs in the copying process, the copying process after the completion time affects the front jobs.

In view of this, as illustrated in FIG. 4C, the information processing system in the embodiment lowers the priority of the copying process after the completion time and suppresses the effect on the front jobs. However, since the front jobs are not necessarily prioritized over the copying process after the completion time in all operations, the information processing system in the embodiment lowers the priority of the copying process depending on setting by a user.

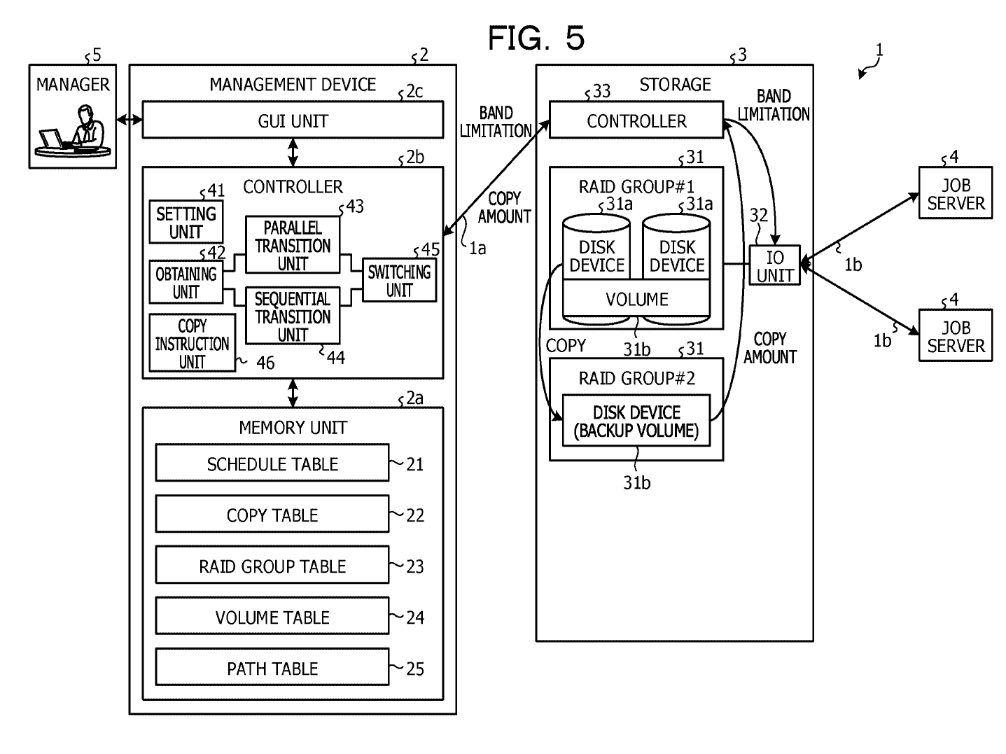

Next, description is given of the configuration of the information processing system in the embodiment. FIG. 5 is a view depicting the configuration of the information processing system in the embodiment. As illustrated in FIG. 5, the information processing system 1 in the embodiment includes a management device 2, a storage 3, and two job servers 4. The management device 2 and the storage 3 are connected by a management path 1a, and the storage 3 and the job servers 4 are connected by job paths 1b. Note that, although two job servers 4 are illustrated herein for the sake of explanation, the information processing system 1 may include any number of job servers 4.

The management device 2 is a device for managing the storage 3 and performs the priority control for the job paths 1b. The storage 3 is a storage device for storing data to be used by the job servers 4. The job servers 4 are devices for performing job processes. Specifically, the job servers 4 perform the job processes by executing job programs.

The management device 2 includes a memory unit 2a, a controller 2b, and a graphical user interface (GUI) unit 2c. The memory unit 2a stores information for managing the storage 3. The memory unit 2a stores a schedule table 21, a copy table 22, a RAID group table 23, a volume table 24, and a path table 25.

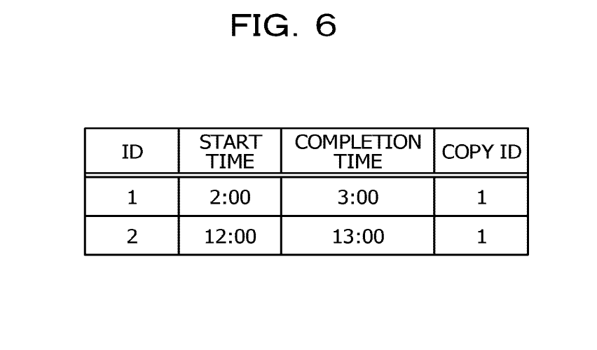

In the schedule table 21, information on a schedule of the copying process is registered. FIG. 6 is a view illustrating an example of the schedule table 21. As illustrated in FIG. 6, in the schedule table 21, an ID, the start time, the completion time, and a copy ID are associated with one another for each copying process.

The ID is a number for identifying an entry of the schedule table 21, and is used to identify the schedule of the copying process. The start time is a start time point of the copying process. The completion time is a completion time point of the copying process. The completion time is a target value set by a manager 5, and is the time at which the copying process is expected to be completed. The copy ID is a number for identifying an entry in the copy table 22. For example, the copying process identified by the number “1” starts at “2:00” and completes at “3:00”, and the number of entry in the copy table 22 is “1”.

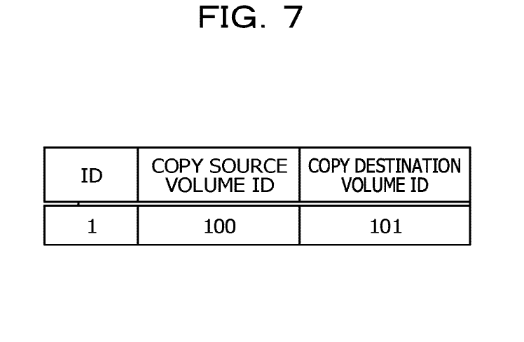

Information on a copy source and a copy destination is registered in the copy table 22. FIG. 7 is a view illustrating an example of the copy table 22. As illustrated in FIG. 7, in the copy table 22, an ID, a copy source volume ID, and a copy destination volume ID are associated with one another for each pair of the copy source and the copy destination.

The ID is a number for identifying the entry of the copying table 22, and is used to identify the pair of the copy source and the copy destination. The copy source volume ID is a number for identifying the volume of the copy source. The copy destination volume ID is a number for identifying the volume of the copy destination. For example, in the pair identified by the number “1”, the number for the volume of the copy source is “100” and the number for the volume of the copy destination is “101”.

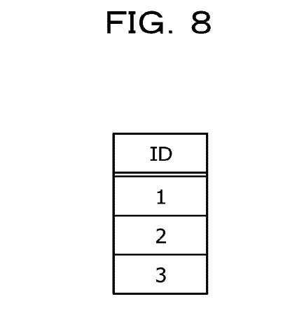

In the RAID group table 23, the information on the RAID group is registered. FIG. 8 is a view illustrating an example of the RAID group table 23. As illustrated in FIG. 8, an ID is registered in the RAID group table 23. The ID is a number for identifying the entry in the RAID group table 23 and is used to identify the RAID group. For example, the RAID groups include a group identified by the number “1”.

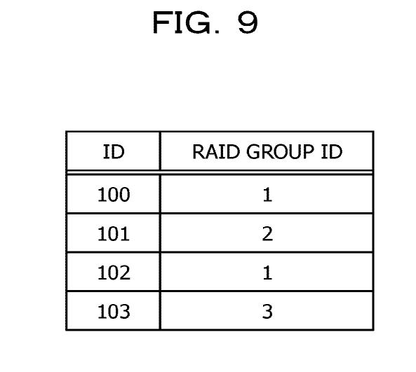

In the volume table 24, information on the volumes is registered. FIG. 9 is a view illustrating an example of the volume table 24. As illustrated in FIG. 9, in the volume table 24, an ID and a RAID group ID are associated with each other for each volume.

The ID is a number for identifying the entry of the volume table 24 and is used to identify the volume. The RAID group ID is a number for identifying the entry in the RAID group table 23. For example, the volume identified by the number “100” belongs to the RAID group identified by the number “1”.

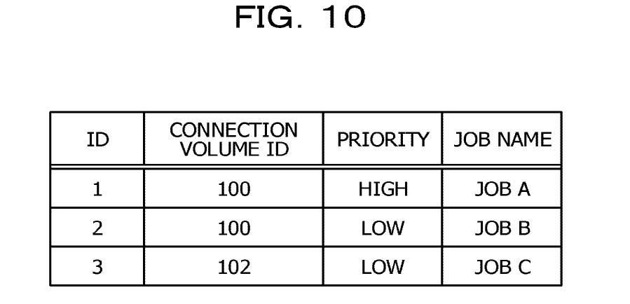

In the path table 25, the information on the job paths 1b is registered. FIG. 10 is a view illustrating an example of the path table 25. As illustrated in FIG. 10, in the path table 25, an ID, a connection volume ID, a priority, and a job name are associated with one another for each job path 1b.

The ID is a number for identifying an entry in the path table 25 and is used to identify the job path 1b. The connection volume ID is a number for identifying the volume to which the job path 1b is connected. The priority is the priority of the front job associated with the job path 1b. The priority is either “high” which indicates that the priority of the front job is high or “low” which indicates that the priority of the front job is low. The job name is the name of the front job associated with the job path 1b.

For example, the work path 1b identified by the number “1” connects the volume identified by the number “100” and the front job identified by the name “job A”, and the priority of the “job A” is high. In other words, the job path 1b identified by the number “1” is the priority path.

Returning to FIG. 5, the controller 2b manages the storage 3 by using the memory unit 2a and information obtained from the storage 3. The controller 2b includes a setting unit 41, an obtaining unit 42, a parallel transition unit 43, a sequential transition unit 44, a switching unit 45, and a copy instruction unit 46.

The setting unit 41 performs registration of information in the tables stored in the memory unit 2a, the update of the information, and the like by communicating with the manager 5 of the information processing system 1 via the GUI unit 2c. For example, the setting unit 41 registers the information on the schedule of the copying process in the schedule table 21 based on the instruction by the manager 5. Moreover, the setting unit 41 registers the information on the pair of the copy source and the copy destination in the copy table 22 based on the instruction by the manager 5. Furthermore, the setting unit 41 registers the information on the job path 1b in the path table 25 based on the instruction by the manager 5.

The obtaining unit 42 obtains information on the progress percentage of the copying process from the storage 3. Specifically, the obtaining unit 42 obtains, as a copy amount, the size of the data for which copying from the storage 3 is completed and calculates the actually-measured progress percentage by referring to the schedule table 21. Moreover, the obtaining unit 42 obtains the size of the copy source volume from the storage 3 and calculates the target progress percentage by referring to the schedule table 21. Then, the obtaining unit 42 sends the calculated actually-measured progress percentage and target progress percentage to the parallel transition unit 43 and the sequential transition unit 44.

The parallel transition unit 43 controls the band limitation in the job paths 1b by using the parallel transition at a fixed sampling interval. Specifically, the parallel transition unit 43 specifies the job paths 1b to be the targets of the priority control by referring to the memory unit 2a. The specified paths 1b are the job paths 1b connected to the volume belonging to the same RAID group as the copy source volume for which the copying process is being performed.

For example, the volume whose copy source volume ID depicted in FIG. 7 is “100” is associated with the RAID group ID of “1” as depicted in FIG. 9, and the volume whose volume ID is “102” is also associated with the RAID group ID of “1”. Thus, in order to limit the access of the front jobs to the volumes with the volume IDs of “100” and “102”, the work paths 1b whose IDs are “1”, “2”, and “3” are specified as the targets of priority control based on the path table depicted in FIG. 10. The job path 1b with the ID of “1” is the priority path and the job paths 1b whose IDs are “2” and “3” are the non-priority paths.

Then, the parallel transition unit 43 compares the actually-measured progress percentage and the target progress percentage. When the actually-measured progress percentage is higher than the target progress percentage, the parallel transition unit 43 instructs the storage 3 to relax the band limitation in both types of the job paths 1b of the priority path and the non-priority path. Meanwhile, when the actually-measured progress percentage is lower than the target progress percentage, the parallel transition unit 43 instructs the storage 3 to strengthen the band limitation in both types of the job paths 1b. Note that the band limitation level in the priority path is lower than that in the non-priority path by a certain difference or a certain ratio.

The sequential transition unit 44 controls the band limitation in the job paths 1b by using the sequential transition at a fixed sampling interval. Specifically, the sequential transition unit 44 specifies the job paths 1b to be the target of the priority control by referring to the memory unit 2a. Then, the sequential transition unit 44 compares the actually-measured progress percentage and the target progress percentage.

Then, the sequential transition unit 44 instructs the storage 3 to relax the band limitation in the priority path when the actually-measured progress percentage is higher than the target progress percentage and relax the band limitation in the non-priority path when the band limitation in the priority path reaches zero. Moreover, the sequential transition unit 44 instructs the storage 3 to strengthen the band limitation in the non-priority path when the actually-measured progress percentage is lower than the target progress percentage and strengthen the band limitation in the priority path when the band limitation in the non-priority path reaches its limit.

The switching unit 45 first instructs the sequential transition unit 44 to perform the priority control and then instructs the parallel transition unit 43 to perform the priority control in the middle of the copying process to perform the priority control in the sequential transition at the start of the copying process and then perform the priority control in the parallel transition from the middle of the copying process. The switching unit 45 determines the timing of switching from the priority control by the sequential transition unit 44 to the priority control by the parallel transition unit 43, based on the remaining time. For example, when the remaining time reaches 40% of the entire process time, the switching unit 45 performs switching from the sequential transition to the parallel transition.

Moreover, the switching unit 45 regularly checks the band limitation situation of the job paths 1b and, in the situation where the usage ratio of the non-priority path is low and the band limitation in the priority path has to be continuously performed in the sequential transition, switches to the parallel transition earlier.

The copy instruction unit 46 instructs the storage 3 to perform the copying process by referring to the schedule table 21 and the copy table 22.

Note that the controller 2b reduces the sampling interval just before the completion of the copying process. In this case, for example, just before the completion is the time period in which the remaining time is equal to or less than 10% of the entire process time. Moreover, when the copying process is not completed before the completion time, the controller 2b instructs the storage 3 to lower the priority of the copying process after the completion time, if set so by the manager 5.

The GUI unit 2c communicates with the manager 5 by using a GUI, receives instructions, information, and the like inputted by the manager 5, and sends them to the controller 2b. For example, the GUI unit 2c receives the information on the schedule of the copying process, the information on the copy source volume and the copy destination volume, the information on the RAID group, the information on the volumes, the information on the priorities of the job paths 1b and the front jobs, and the like and sends them to the controller 2b.

The storage 3 includes RAID groups 31 expressed as a RAID group #1 and a RAID group #2, an IO unit 32, and a controller 33. The RAID groups 31 include multiple disk devices 31a. Moreover, a volume 31b is stored in the RAID group 31. FIG. 5 illustrates a situation where the volume 31b stored in the RAID group #1 is copied to the RAID group #2 for backup. Note that, although two RAID groups 31 are illustrated in FIG. 5, the storage 3 may have any number of RAID groups 31.

The IO unit 32 executes input from the job servers 4 to the storage 3 and output from the storage 3 to the job servers 4 using the job paths 1b. The IO unit 32 executes the band limitation in the job paths 1b based on the instruction from the controller 33.

The controller 33 controls the storage 3. The controller 33 controls the copying process of the volume 31b based on the instruction from the management device 2. Moreover, the controller 33 instructs the IO unit 32 to execute the band limitation in the job paths 1b based on the instruction from the management device 2. The controller 33 receives the instruction from the management device 2 by using the management path la. Moreover, the controller 33 obtains the copy amount from the RAID groups 31 and sends the copy amount to the management device 2 by using the management path 1a.

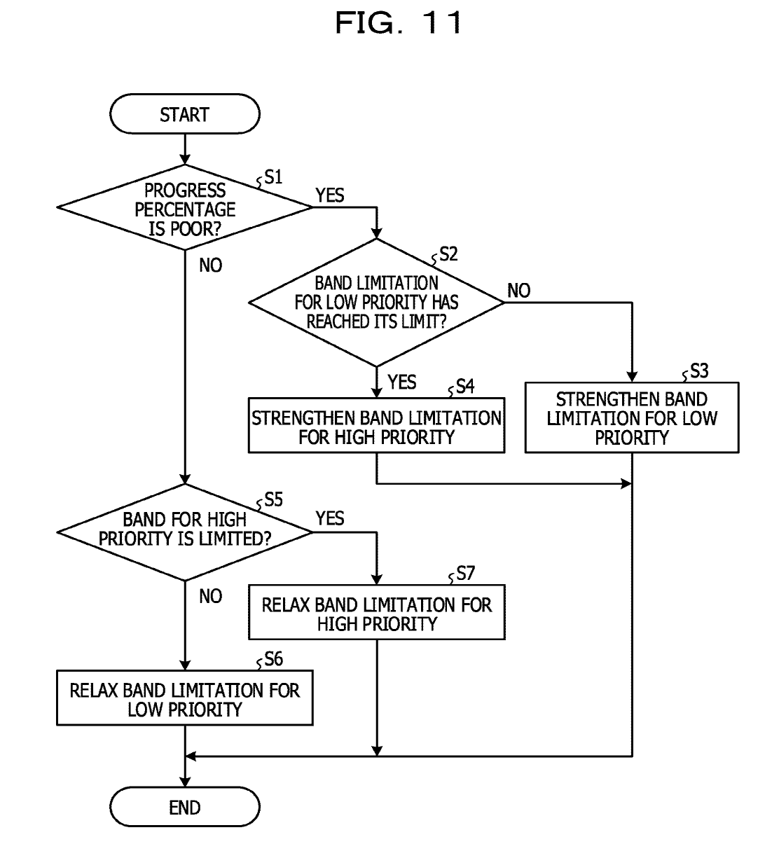

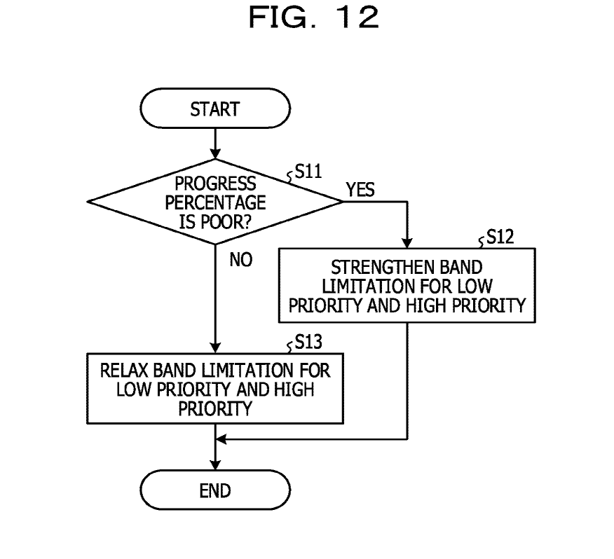

Next, description is given of a flow of processes performed by the sequential transition unit 44 and a flow of processes performed by the parallel transition unit 43. FIG. 11 is a flowchart depicting the flow of processes performed by the sequential transition unit 44, and FIG. 12 is a flowchart depicting the flow of processes performed by the parallel transition unit 43.

Note that, in FIGS. 11 and 12, the progress percentage being poor is the case where the actually-measured progress percentage is lower than the target progress percentage, and the progress percentage not being poor is the case where the actually-measured progress percentage is higher than the target progress percentage. Moreover, when the target progress percentage is equal to the actually-measured progress percentage, the processes in FIGS. 11 and 12 are not activated. Furthermore, the low priority expresses the non-priority path and the high priority expresses the priority path.

As illustrated in FIG. 11, the sequential transition unit 44 determines whether the progress percentage is poor (step S1). When the progress percentage is poor, the sequential transition unit 44 determines whether the band limitation for the low priority has reached its limit (step S2). When the band limitation for the low priority has not reached its limit, the sequential transition unit 44 strengthens the band limitation for the low priority (step S3). When the band limitation for the low priority has reached its limit, the sequential transition unit 44 strengthens the band limitation for the high priority (step S4).

Meanwhile, when the progress percentage is not poor, the sequential transition unit 44 determines whether the band for the high priority is limited (step S5). When no band for the high priority is limited, the sequential transition unit 44 relaxes the band limitation for the low priority (step S6). When the band for the high priority is limited, the sequential transition unit 44 relaxes the band limitation for the high priority (step S7).

Moreover, as illustrated in FIG. 12, the parallel transition unit 43 determines whether the progress percentage is poor (step S11). When the progress percentage is poor, the parallel transition unit 43 strengthens the band limitation for the low priority and the high priority (step S12). When the progress percentage is not poor, the parallel transition unit 43 relaxes the band limitation for the low priority and the high priority (step S13).

As described above, the sequential transition unit 44 and the parallel transition unit 43 is capable of completing the copying process before the completion time by strengthening and relaxing the band limitation based on the progress percentage.

As described above, in the embodiment, the names of the front jobs and the priorities of the front jobs are registered in the path table 25 stored in the memory unit 2c of the management device 2, in association with each job path 1b. Then, the controller 2b of the management device 2 controls the band limitation in the job paths 1b based on the priorities of the front jobs when controlling the band limitation in the job paths 1b based on the target progress percentage and the actually-measured progress percentage of the copying process. Accordingly, the information processing system 1 is capable of suppressing delay of an important front job.

Moreover, in the embodiment, the parallel transition unit 43 performs the less strict band limitation in the priority path than the non-priority path. Accordingly, the information processing system 1 is capable of making the delay of the important front job smaller than the delay of the other front jobs.

Furthermore, in the embodiment, the sequential transition unit 44 performs the band limitation in the non-priority path and, when the band limitation in the non-priority path reaches its limit, starts the band limitation in the priority path. Accordingly, the information processing system 1 is capable of making the delay of the important front job smaller than the delay of the other front jobs.

Moreover, in the embodiment, the switching unit 45 first instructs the sequential transition unit 44 to perform the priority control and then instructs the parallel transition unit 43 to perform the priority control from the middle of the copying process. Accordingly, the information processing system 1 is capable of avoiding the band from being limited in the priority path in an early stage and also suppressing the possibility of the completion of the copying process being delayed.

Furthermore, in the embodiment, the controller 2b performs the priority control also for the job path 1b connected to the volumes belonging to the same RAID group 31 as the volume used in the copying process. Accordingly, the information processing system 1 is capable of further suppressing the delay of the important front job.

Moreover, in the embodiment, the controller 2b reduces the sampling interval when the ratio of the remaining time to the entire process time for the copying process reaches a predetermined threshold. Accordingly, when there is a large amount of sudden access for the front jobs just before the completion of the copying process, it is possible for the information processing system 1 to complete the copying process before the completion time.

Moreover, in the embodiment, when the copying process is not completed before the completion time, the controller 2b instructs the storage 3 to reduce the priority of the copying process. Accordingly, the information processing system 1 is capable of suppressing the effect on the front jobs when the front jobs increase after the completion time.

Note that, in the embodiment, although description is given of the management device 2, a management program having the same functions as the management device 2 may be obtained by achieving the configuration of the management device 2 with software. Description is given of a computer which executes the management program.

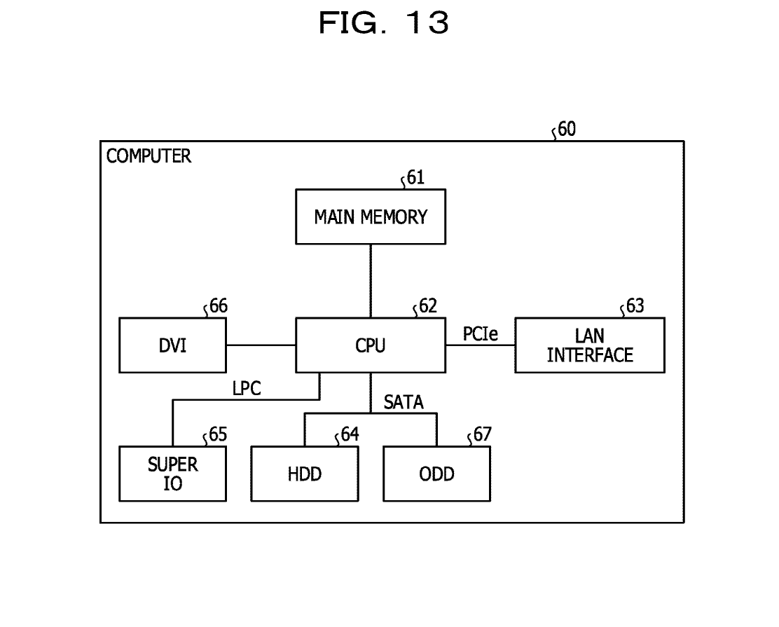

FIG. 13 is a view illustrating a hardware configuration of the computer which executes the management program in the embodiment. As illustrated in FIG. 13, the computer 60 includes a main memory 61, a CPU 62, a local area network (LAN) interface 63, and a hard disk drive (HDD) 64. Moreover, the computer 60 includes a super input-output (IC)) 65, a digital visual interface (DVI) 66, and an optical disk drive (ODD) 67.

The main memory 61 is a memory in which a program and intermediate results of executing the program are stored. The CPU 62 is a central processing unit which reads the program from the main memory 61 and executes the program. The CPU 62 includes a chipset having a memory controller.

The LAN interface 63 is an interface for connecting the computer 60 to another computer via LAN. The HDD 64 is a disk device for storing the program and data, and the super IO 65 is an interface for connecting input devices such as a mouse and a keyboard. The DVI 66 is an interface for connecting a liquid crystal display device, and the ODD 67 is a device for reading and writing data from and to a DVD.

The LAN interface 63 is connected to the CPU 62 via a PCI express (PCIe), and the HDD 64 and the ODD 67 are connected to the CPU 62 via a serial advance technology attachment (SATA). The super IO 65 is connected to the CPU 62 via a low pin count (LPC).

The management program executed by the computer 60 is stored in the DVD and is installed into the computer 60 by being read from the DVD by the ODD 67. Alternatively, the management program is stored in a database or the like of another computer system connected to the computer 60 via the LAN interface 63, and is installed into the computer 60 by being read from the database or the like. Then, the installed management program is stored in the HDD 64 and is loaded onto the main memory 61 to be executed by the CPU 62.

Moreover, although description is given of the case where the parallel transition and the sequential transition are combined in the embodiment, the management device 2 may perform the priority control by using one of the parallel transition and the sequential transition.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing device comprising:
a memory that stores priority information indicating a plurality of priorities for each of a plurality of paths used for access by a plurality of jobs to a storage device which stores data to be accessed; and
a processor coupled to the memory and the processor configured to:
during a copying process of the data, specify a progress degree of a copying process; and
perform control of a band width allocation for at least one of the plurality of paths based on the priority information stored in the memory and based on the progress degree of a copying process of the data.

2. The information processing device according to claim 1, wherein the processor is configured to:
performs, in the control, less strict band limitation in a path, included in the plurality of paths, with a first priority than band limitation in a path, included in the plurality of paths, with a second priority, the first priority is a higher priority than the second priority.

3. The information processing device according to claim 1, wherein the processor is configured to:
perform, in the control, band limitation in a path, included in the plurality of paths, with a second priority; and
perform, in the control, band limitation in a path, included in the plurality of paths, with a first priority only when the band limitation in the path with the second priority reaches a limit, the first priority is a higher priority than the second priority.

4. The information processing device according to claim 1, wherein the processor is configured to:
perform, in the control, a first control when a remaining time to an expected completion time of the copying process reaches a predetermined value, the first control including performing less strict band limitation in a path, included in the plurality of paths, with a first priority than band limitation in a path, included in the plurality of paths, with a second priority, the first priority is a higher priority than the second priority; and
perform, in the control, a second control until the remaining time reaches a predetermined value, the second control including performing band limitation in a path, included in the plurality of paths, with the second priority and performing band limitation in a path, included in the plurality of paths, with a first priority only when the band limitation in the path with the second priority reaches a limit.

5. The information processing device according to claim 1, wherein the processor is configured to:
perform the control also on a path connected to a volume belonging to the same Redundant Arrays of Inexpensive Disks (RAID) group as a volume used in the copying process.

6. The information processing device according to claim 1, wherein the processor is configured to:
reduce a time interval of performing the control when a ratio of a remaining time to an entire process time of the copying process reaches a predetermined threshold.

7. The information processing device according to claim 1, wherein the processor is configured to:
lower the priority of the copying process when the copying process is not completed before an expected completion time.

8. An information processing system comprising:
a storage device that stores data to be accessed;
a job device including:
a first memory; and
a first processor coupled to the first memory and the first processor configured to:
execute a plurality of jobs by using the data stored in the storage device; and
a management device including:
a second memory that stores priority information indicating a plurality of priorities for each of a plurality of paths used for access by the plurality of jobs to the storage device; and
a second processor coupled to the memory and the second processor configured to:
during a copying process of the data, specify a progress degree of a copying process; and
perform control of a band width allocation for at least one of the plurality of paths based on the priority information stored in the memory and based on the progress degree of a copying process of the data.

9. A non-transitory computer-readable storage medium which stores an information processing program that causes a computer to execute a process, the process comprising:
during a copying process of data, specifying a progress degree of a copying process, the data being stored in a storage device; and
performing control of a band width allocation for at least one of a plurality of paths based on priority information stored in a memory and based on the progress degree of a copying process of the data, the priority information indicating a plurality of priorities for each of the plurality of paths used for access by the plurality of jobs to the storage device.
